(19) United States
(12) Patent Application Publication
(10) Pub. No.: US 2016/0076972 A1
(43) Pub. Date: Mar. 17, 2016

(54) METHOD OF ANALYZING BONDED PART DURABILITY TEST RESULT DATA

(71) Applicants: Hyundai Motor Company, Seoul (KR); Kia Motors Corporation, Seoul (KR)

(72) Inventor: Byeong Wook Kang, Hwaseong (KR)

(73) Assignees: Kia Motors Corporation; Hyundai Motor Company

(21) Appl. No.: 14/556,121

(22) Filed: Nov. 29, 2014

(30) Foreign Application Priority Data
Sep. 17, 2014 (KR) 10-2014-0123883

(51) Int. Cl. G01M 17/00; G01B 21/08

(52) U.S. Cl. CPC G01M 17/00; G01B 21/08

(57) ABSTRACT

A method of analyzing bonded part durability test result data provides a guide line for how much the thickness of a steel sheet forming a bonded part may be decreased while maintaining original equivalent durability of the bonded part. The method includes steps of: calculating a reference durability lifespan approximation function capable of estimating a durability lifespan value of a bonded part using a thickness value of at least one of two steel sheets; calculating a target durability lifespan approximation function capable of estimating the durability lifespan value of the bonded part; calculating an inverse function of the target durability lifespan approximation function capable of deriving a thickness value of the at least one steel sheet; and calculating any target steel sheet thickness value by substituting any target lifespan value into the inverse function of the target durability lifespan approximation function.

### CROSS-REFERENCE TO RELATED APPLICATION

This application is based on and claims under 35 U.S.C. §119(a) the benefit of Korean Patent Application No. 10-2014-0123883, filed on Sep. 17, 2014 in the Korean Intellectual Property Office, the disclosure of which is incorporated herein in its entirety by reference.

### BACKGROUND

(a) Field of the Invention

The present invention relates to a method of analyzing bonded part durability test result data, and more particularly, to a method of analyzing bonded part durability test result data capable of providing a guide line for how much the thickness of a steel sheet forming a bonded part may be decreased while maintaining original equivalent durability of the bonded part

(b) Description of the Related Art

According to the related art, a thickness of a steel sheet has been determined in consideration of only strength of the steel sheet without predicting durability of bonded parts, and a vehicle body has been manufactured depending on the determined thickness of the steel sheet

Increasing the strength of the steel sheet and decreasing the thickness of the steel sheet might satisfy durability or strength of a basic material itself. However, even though the strength of the basic material is increased, the thickness of the steel sheet has been decreased, such that the durability of the bonded part has decreased. Therefore, in the case in which an original component does not have a sufficient durability margin, it would not pass a practical durability test, such that the thickness of the steel sheet may need to be restored to an original state.

In addition, since there is no easy judging reference and analyzing method for whether to decrease the thickness of the steel sheet forming the bonded part while maintaining equivalent durability, it would be inefficient to evaluate hundreds of components of the vehicle body of the vehicle.

### SUMMARY

inventionAn aspect of the present invention provides a method of analyzing bonded part durability test result data capable of providing a guide line for how much the thickness of a steel sheet forming a bonded part may be decreased while maintaining original equivalent durability of the bonded part.

According to an exemplary embodiment of the present invention, a method of analyzing bonded part durability test result data includes the steps of: calculating a reference durability lifespan approximation function capable of estimating a durability lifespan value of a bonded part using a thickness value of any one of two steel sheets (i.e., at least one of the two steel sheets) to which a reference bonding method of bonding the two steel sheets to each other is applied as an independent variable; calculating a target durability lifespan approximation function capable of estimating the durability lifespan value of the bonded part using the thickness value of any of the at least one of two steel sheets to which a target bonding method capable of increasing a durability lifespan value as compared with the reference bonding method is applied as an independent variable; calculating an inverse function of the target durability lifespan approximation function capable of deriving a thickness value of the at least one steel sheet, which is the independent variable in the target durability lifespan approximation function calculating the same durability lifespan value as a specific durability lifespan value calculated when the independent variable in the reference durability lifespan approximation function is a specific thickness value; and calculating any target steel sheet thickness value by substituting any target lifespan value into the inverse function of the target durability lifespan approximation function.

### BRIEF DESCRIPTION OF THE DRAWINGS

The above and other objects, features and advantages of the present invention will be more apparent from the following detailed description taken in conjunction with the accompanying drawings

FIG. 1 is a flow chart showing a method of analyzing bonded part durability test result data according to an exemplary embodiment of the present invention.

FIG. 2 is a view showing a bonded sample used in a method of measuring durability of a bonded part and a tension load applying device.

FIG. 3 is a graph showing a thickness and a lifespan about a load lower limit value of a bonded part bonded through a reference bonding method and a target bonding method.

FIG. 4 is a graph showing a thickness and a lifespan about a load upper limit value of the bonded part bonded through the reference bonding method and the target bonding method.

FIG. 5 is a graph a reference durability lifespan approximation function and a target durability lifespan approximation function.

FIG. 6 is a graph a thickness value of a steel sheet to which the reference bonding method is applied and any target steel sheet thickness value.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The present invention relates to a method of testing durability of a bonded part and analyzing data thereof, and more particularly, to an analyzing method of arranging a function of a durability lifespan using a thickness of a steel sheet as an independent variable in durability lifespan data of a bonded part sample to which a complex load is applied, dividing a load, which is a third element, into upper and lower limits to configure lines, and quantitatively calculating a target thickness from any original thickness along a durability lifespan equivalent line in each load. Through this, it becomes very easy to measure and manage whether or not a vehicle to which a target bonding method is applied is further lightened as compared with a vehicle to which a reference bonding method is applied and the possibility that the vehicle to which a target bonding method will be lightened and primary judgment of hundreds of unit components in lightening a vehicle may be easily performed.

Many factors such as durability, collision, rigidity, and the like, are considered in determining a portion in which a thickness of the steel sheet is decreased at the time of lightening the vehicle by decreasing the thickness of the steel sheet. Among them, the most important factor is the durability of the bonded part. Generally, as the thickness of the steel sheet is decreased, a durability lifespan is rapidly decreased exponentially. Therefore, several production technology elements for increasing the lifespan of the bonded part are applied, and an evaluation for them is performed. However, it is very difficult to evaluate usefulness of a method modified as compared with an existing bonding method, and there is no quantitative guide line for how much the steel sheet may be lightened without sacrificing the durability.

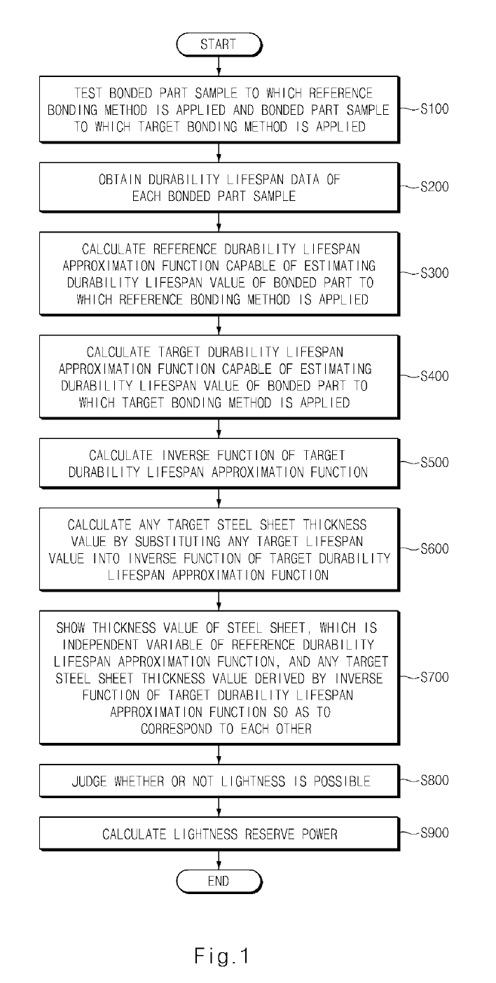

An exemplary embodiment of the present invention will be described in detail with reference to the accompanying drawings. As shown in FIG. 1, a method of analyzing bonded part durability test result data according to an exemplary embodiment of the present invention includes a step (S300) of calculating a reference durability lifespan approximation function capable of estimating a durability lifespan value of a bonded part using a thickness value of any one of two steel sheets to which a reference bonding method of bonding the two steel sheets to each other is applied as an independent variable, a step (S400) of calculating a target durability lifespan approximation function capable of estimating the durability lifespan value of the bonded part using a thickness value of any one of two steel sheets to which a target bonding method capable of increasing a durability lifespan value as compared with the reference bonding method is applied as an independent variable, a step (S500) of calculating an inverse function of the target durability lifespan approximation function capable of deriving a thickness value of the steel sheet, which is the independent variable in the target durability lifespan approximation function calculating the same durability lifespan value as a specific durability lifespan value calculated when the independent variable in the reference durability lifespan approximation function is a specific thickness value, and a step (S600) of calculating any target steel sheet thickness value by substituting any target lifespan value into the inverse function of the target durability lifespan approximation function.

Then, a corresponding showing step (S700) in which an original thickness value of the steel sheet, which is the independent variable of the reference durability lifespan approximation function, and any target steel sheet thickness value derived by the inverse function of the target durability lifespan approximation function are shown on a graph so as to correspond to each other is performed. In addition, the original thickness value of the steel sheet and any target steel sheet thickness value shown so as to correspond to each other are compared with each other to judge whether or not lightness is possible (S800). In addition, durability lifespans of bonded samples are repeatedly tested, approximation functions are calculated, and it is repeatedly judged whether or not lightness is possible, thereby calculating lightness reserve power (S900). In particular, the lightness reserve power is a deviation value between the original thickness of the steel sheet and any target steel sheet thickness value that is repeatedly derived.

The method of analyzing bonded part durability test result data according to an exemplary embodiment of the present invention configured as described above will be described in more detail below. The durability lifespan approximation function and the target durability lifespan approximation function are calculated as approximation functions deriving a plurality of durability lifespan values using the thickness value of the steel sheet as the independent variable by curve-fitting a plurality of durability lifespan values repeatedly measured in a load lower limit value to a load upper limit value that may be generated in the vehicle through a method of measuring durability of a bonded part

In the method of measuring durability of a bonded part, durability lifespan data are obtained by repeatedly applying a load to the bonded sample inclined at a specific angle so as to simultaneously apply the load in a vertical direction and a horizontal direction in order to simulate an actual load state of a vehicle bonded part. In other words, in the method of measuring durability of a bonded part, the load lower limit value to the load upper limit value are simultaneously applied to bonded parts of two steel sheets in the vertical direction and the horizontal direction to test a bonded part sample to which the reference bonding method is applied and a bonded part sample to which the target bonding method is applied (S100). The durability lifespan data of the bonded parts are obtained through the test (S200).

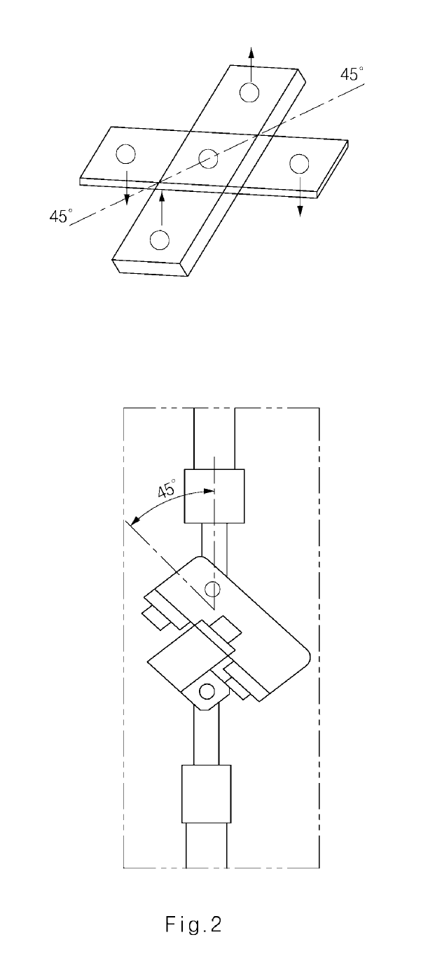

As the bonded sample, as shown in FIG. 2, unit samples having L*W (for example, 100 mm*25 mm) and a thickness of t_{lwr} to tᵤₚᵣ (for example, 0.8 mm to 1.4 mm) intersect with each other in a perpendicular direction, and intersection central portions are bonded to each other. A tension load is repeatedly applied to the bonded sample having a cross shape using a tension load applying device shown in FIG. 2.

In particular, a load lower limit value of 0.01 Pₘᵢₙ to Pₘᵢₙ (for example, 120N to 1200N) and a load upper limit value of 0.1 Pₘₐₓ to Pₘₐₓ (for example, 180N to 1800N) are used as a test condition. Pₘᵢₙ and Pₘₐₓ, which are a lower limit value and an upper limit value, respectively, of a durability normal load of the bonded part, are values determined in consideration of measured values measured in the bonded part as the vehicle is actually driven on a road, a frequency analysis, and durability severity and may be changed depending on materials of the samples and a method of bonding the samples to each other.

Lifespan data depending on each thickness are obtained with respect to the samples to which the reference bonding method and the target bonding method are applied, respectively, in the load lower limit value, and lifespan data in each case are obtained by the same method also in the load upper limit value.

The reference bonding method means a resistance spot welding method in an exemplary embodiment of the present invention. However, all bonding methods such as a resistance spot welding method, a projection welding method, an SPR method, a rivet bonding method, an arc welding method, an adhering method, a laser welding method, a friction stir welding method, and the like, may be used as the reference bonding method used in the vehicle.

The target bonding method means a hybrid bonding method in which both of resistance spot welding and a structural adhesive are used in an exemplary embodiment of the present invention, but may also mean a method capable of improving durability of the bonded part as compared with the reference bonding method among all bonding methods used in the vehicle.

The following Table 1 is a result table obtained by bonding a plurality of samples manufactured at an interval of a mass production thickness (for example, 0.2 mm) in a section of t_{lwr} to tᵤₚᵣ (for example, 0.8 mm to 1.4 mm) to each other through the reference bonding method and the target bonding method and applying tension loads of the load lower limit value and the load upper limit value to the samples bonded to each other.

TABLE 1

| | Load Lower Limit Value | | Load Upper Limit Value | |
|---|---|---|---|---|
| | (Pₘᵢₙ, 1200N) | | (Pₘₐₓ, 1800N) | |
| | Reference | Target | Reference | Target |
| Thickness | Bonding | Bonding | Bonding | Bonding |
| (mm) | Method | Method | Method | Method |
| tᵤₚᵣ(1.4 t) | n₄(97164) | N₄(Fatigue Limit | n′₄(18332) | N′₄(2558628) |
| | | Excess) | | |
| t₃(1.2 t) | n₃(44928) | N₃(5000000) | n′₃(17232) | N′₃(341734) |
| t₂(1.0 t) | n₂(22505) | N₂(637131) | n′₂(8373) | N′₂(30780) |
| t_{lwr}(0.8 t) | n₁(10017) | N₁(77829) | n′₁(4966) | N′₁(12473) |

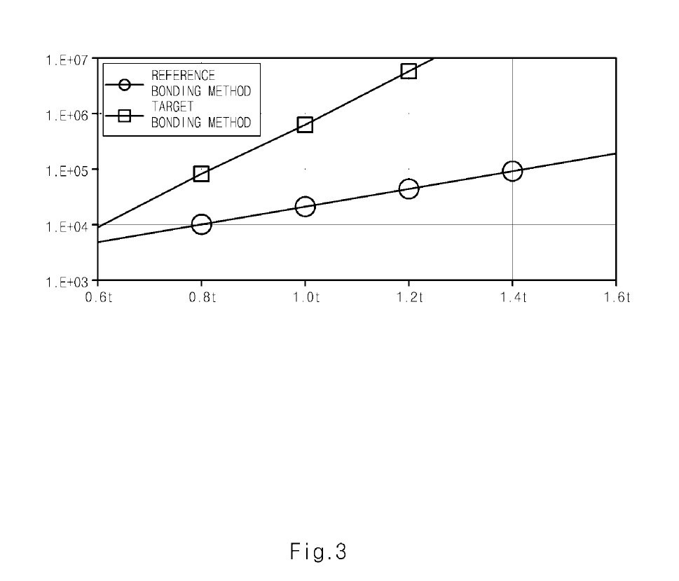

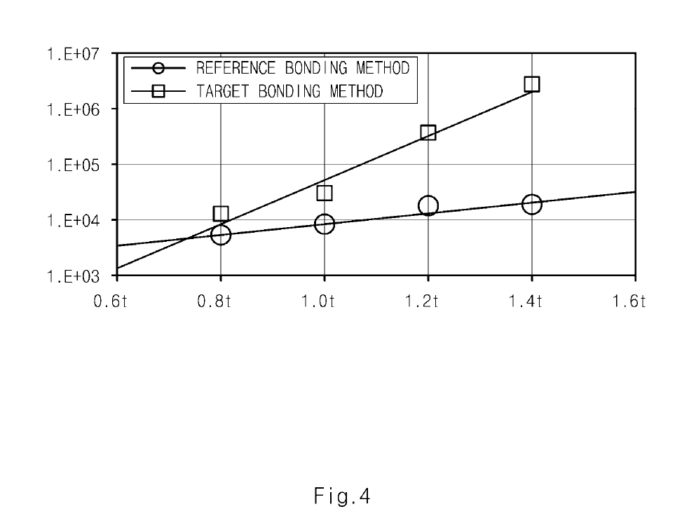

In the respective sample bonded parts to which the reference bonding method and the target bonding method are applied, the reference durability lifespan approximation function and the target durability lifespan approximation function using the thicknesses of the samples as the independent variables are calculated by curve-fitting the durability lifespans of the respective sample bonded parts obtained in a range of the load lower limit value and the load upper limit value that may be represented in the vehicle (S300 and S400) (See FIGS. 3 and 4).

The reference durability lifespan approximation function and the target durability lifespan approximation function are shown on graphs, respectively, thereby making it possible to show an equivalent durability lifespan line from a reference bonding line drawing to a target bonding line drawing. The equivalent durability lifespan line may be represented by the following Equation 1.

$$\{ \begin{matrix}{L}_{b} = {F}_{b} ( t ) \\ {L}_{T} = {F}_{T} ( t )\end{matrix} \} \to {L}_{b} = {L}_{T} \qquad [ Mathematical Equation 1 ]$$

In the above equation, L_{b}is a bonded part durability lifespan by the reference bonding method, L_{T} is a bonded part durability lifespan by the target bonding method, f_{b}(t) is a reference durability lifespan approximation function, f_{T}(t) is a target durability lifespan approximation function, and t is a thickness of a steel sheet

As follows, in each case, four measured data of Table 1 are calculated by an approximation function by using a thickness as an independent variable through the curve-fitting. In particular, a plurality of bonded parts by the target bonding method may be simultaneously compared with one bonded part by the reference bonding method.

In the load lower limit value, the reference durability lifespan approximation function is represented by L_{b,lower limit}=f_{b,lower limit}(t)=18.991e^{10.407t}. In the load lower limit value, the target durability lifespan approximation function is represented by L_{T,lower limit}=f_{T,lower limit}(t)=506.94e^{3.7538t}. In the load upper limit value, the reference durability lifespan approximation function is represented by L_{b,upper limit}=f_{b,upper limit}(t)=5.5162e^{9.1891t}. In the load upper limit value, the target durability lifespan approximation function is represented by L_{T,upper limit}=f_{T,upper limit}(t)=834.3e^{2.3199t}.

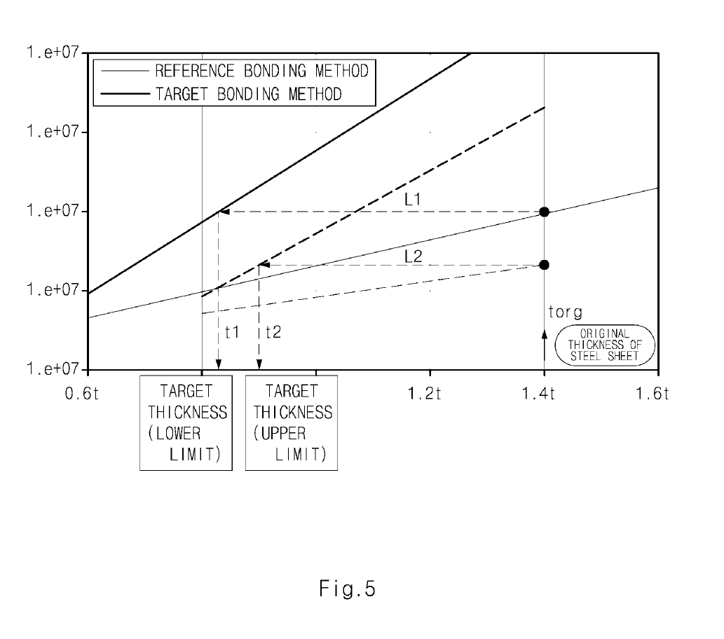

FIG. 5 is a graph showing the reference durability lifespan approximation functions in the load lower limit value and the load upper limit value and the target durability lifespan approximation functions in the load lower limit value and the load upper limit value calculated as described above.

In FIG. 5, t_{org} is a thickness of a steel sheet. A durability lifespan in the graph of the reference durability lifespan approximation function of the load lower limit value corresponding to the thickness t_{org} is L₁. When a line is drawn from the graph of the reference durability lifespan approximation function of the load lower limit value to the graph of the target durability lifespan approximation function of the load lower limit value along an equivalent line of L₁ so as to have the same durability lifespan as L₁, it may be appreciated that when the durability lifespan in the graph of the target durability lifespan approximation function of the load lower limit value is L₁, the thickness is t₁.

This means that a durability lifespan of steel sheets having a thickness of t_{org} and bonded to each other through the reference bonding method is the same as that of steel sheets having a thickness of t₁ and bonded to each other through the target bonding method.

Similarly, in the case in which the thickness of the steel sheet in the durability lifespan approximation function of the load lower limit value is t_{org}, when a line is drawn from the graph of the reference durability lifespan approximation function of the load upper limit value to the graph of the target durability lifespan approximation function of the load upper limit value along an equivalent line of L₂, which is a durability lifespan, it may be appreciated that when the durability lifespan in the graph of the target durability lifespan approximation function of the load upper limit value is L₂, the thickness is t₂.

Therefore, a target thickness may be very easily and quantitatively found from any steel sheet thickness in consideration of both of the load upper limit value and the load lower limit value on the assumption that an equivalent durability lifespan is maintained.

In other words, the inverse function of the target durability lifespan approximation function is calculated (S500). Then, any durability lifespan, that is, a target lifespan is substituted into the inverse function of the target durability lifespan approximation function to finally calculate the thickness of the steel generating any durability lifespan at the time of performing working through the target bonding method, that is, the target thickness (S600). This is represented by a general function form of the following Equation 2.

[Mathematical Equation 2]

Since L_{T}=f_{T}(t_{T})→t_{T}=f¹_{T}(L_{T})→L_{b}=L_{T}, t_{T}=f¹_{T}(f_{b}(t_{b}))

In the above equation, t_{T,lower limit} and t_{T,upper limit} are calculated to calculate the target thickness. In order to convert conceptual contents in the graph into numerical values, the following calculation processes are required. First, in order to convert t_{T,lower limit} and t_{T,upper limit} into a specific function, the durability lifespan in a reference bonding line drawing represented by a function of an original thickness is substituted into inverse function of the target durability lifespan approximation function, and equivalent lifespan target thickness functions in the load lower limit value and the load upper limit value are calculated as follows.

An equivalent lifespan target thickness in the load lower limit value is calculated by (LN(506.94*EXP(3.7538*original thickness))-LN(18.991))/10.407. In this equation, t_{T,lower limit}=f¹_{T,lower limit}(f_{b,lower limit}(t_{b})). An equivalent lifespan target thickness in the load upper limit value is calculated by (LN(834.3*EXP(2.3199*original thickness))-LN(5.5162))/9.1891. In this equation,

t_{T,upper limit}=f¹_{T,upper limit}(f_{b,upper limit}(t_{b})).

When all of thicknesses of steel sheets used in a vehicle body are substituted into the equations for calculating the equivalent lifespan target thickness in the load lower limit value and calculating the equivalent lifespan target thickness in the load upper limit value, results as shown in the following Table 2 are obtained.

TABLE 2

| | Equivalent Lifespan Target | | Target Thickness | |
|---|---|---|---|---|
| | Thickness | | (Corresponding to | |
| Original | Lower Limit | Upper Limit | Mass Production | Judgment of |
| Thickness (t_{b1}) | Value (t_{T, lower limit}) | Value (t_{T, upper limit}) | Steel Sheet) | Lightness |
| t_{b10}(2.3 t) | t_{T10, lower limit}(1.15) | t_{T10, upper limit}(1.13) | t_{T10}(1.2 t) | Possible |
| t_{b9}(2.0 t) | t_{T9, lower limit}(1.04) | t_{T9, upper limit}(1.05) | t_{T9}(1.2 t) | Possible |
| t_{b8}(1.8 t) | t_{T8, lower limit}(0.96) | t_{T8, upper limit}(1.00) | t_{T8}(1.0 t) | Possible |
| t_{b7}(1.6 t) | t_{T7, lower limit}(0.89) | t_{T7, upper limit}(0.95) | t_{T7}(1.0 t) | Possible |
| t_{b6}(1.4 t ) | t_{T6, lower limit}(0.82) | t_{T6, upper limit}(0.90) | t_{T6}(1.0 t) | Possible |
| t_{b5}(1.2 t) | t_{T5, lower limit}(0.75) | t_{T5, upper limit}(0.85) | t_{T5}(1.0 t) | Possible |
| t_{b4}(1.0 t) | t_{T4, lower limit}(0.68) | t_{T4, upper limit}(0.80) | t_{T4}(0.8 t) | Possible |
| t_{b3}(0.9 t) | t_{T3, lower limit}(0.64) | t_{T3, upper limit}(0.77) | t_{T3}(0.8 t) | Possible |
| t_{b2}(0.8 t) | t_{T2, lower limit}(0.60) | t_{T2, upper limit}(0.75) | t_{T2}(0.8 t) | Impossible |
| t_{b1}(0.7 t) | t_{T1, lower limit}(0.57) | t_{T1, upper limit}(0.72) | t_{T0}(0.8 t) | Impossible |

As shown in FIG. 2, a larger thickness in the equivalent lifespan target thicknesses in the load lower limit value and the load upper limit value becomes an actual target thickness in which a margin is considered. Since steel sheets that are actually mass-produced are produced in a unit of 0.2 mm in the case in which a thickness thereof is approximately 0.1 t or more and are produced in a unit of 0.1 mm in the case in which a thickness thereof is approximately 0.1 t or less, a fmal target thickness, that is, any target steel sheet thickness value may be quantitatively determined to be a thickness of the steel sheets that may be mass-produced in consideration of this.

Referring to Table 2, in the case of steel sheets having a thickness of t_{b2} or less (for example, 0.8 t), a target thickness is larger than or equal to an original thickness, which is meaningless in terms of lightness. Therefore, it is judged that lightness is impossible. In the case of steel sheets having a thickness of t_{b3} or more (for example, 0.9 t), a target thickness is smaller than an original thickness, such that it is judged that lightness is possible. In more detail, when a fmal target thickness in which the target steel sheet thicknesses of the load lower limit value and the load upper limit value are considered is smaller than the original thickness of the steel sheet, the lightness is possible. However, when the fmal target thickness is larger than the original thickness of the steel sheet, the lightness is impossible. That is, it becomes easy to judge whether or not the lightness is possible through the present invention.

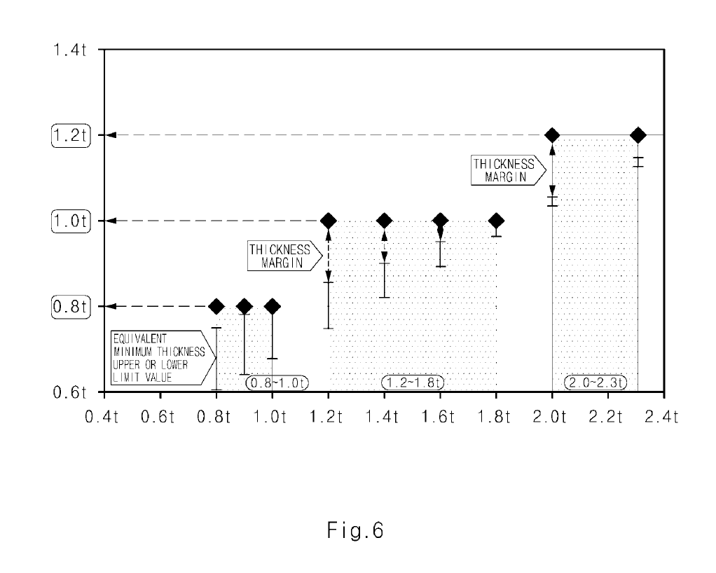

FIG. 6, which is a graph showing an original thickness value of a steel sheet to which the reference bonding method is applied and any target steel sheet thickness value so as to correspond to each other, shows data of Table 2 (S700). Through a comparison graph as shown in FIG. 6, differences between original thicknesses of the respective steel sheets and final target thicknesses in which the upper limit value of the equivalent lifespan target thickness and mass production of the steel sheets are considered may be visualized, such that it may be judged whether or not the lightness is possible (S800). When it is defined as a thickness margin, thickness margins for each steel sheet specification may be recognized at a glance. In addition, the durability lifespans of the bonded samples are repeatedly tested, the approximation functions are calculated and shown on graphs, and it is repeatedly judged whether or not the lightness is possible, thereby calculating the lightness reserve power (S900).

In the present invention, prediction results of durability characteristics of the bonded part different from strength of the steel sheet in a sample level are used. Before a practical test, it may be judged how much the thickness of a steel sheet having any thickness may be decreased while maintaining equivalent durability of the bonded part. In addition, a quantitative lightness guide line depending on a decrease in a thickness may be provided.

Further, primary judgment of hundreds of unit components of the vehicle body in terms of the lightness may be easily performed through a mechanical process such as functionalization of durability data line drawings and inverse function substitution.

As set forth above, with the method of analyzing bonded part durability test result data according to an exemplary embodiment of the present invention, it is possible to provide a guide line for how much the thickness of a steel sheet forming a bonded part may be decreased while maintaining original equivalent durability of the bonded part

In addition, it becomes very easy to measure and manage whether or not a vehicle to which a target bonding method is applied is further lightened as compared with a vehicle to which a reference bonding method is applied and the possibility that the vehicle to which a target bonding method will be lightened.

Further, primary judgment of hundreds of unit components in lightening a vehicle both may be easily performed.

Hereinabove, although the present invention has been described with reference to exemplary embodiments and the accompanying drawings, the present invention is not limited thereto, but may be variously modified and altered by those skilled in the art to which the present invention pertains without departing from the spirit and scope of the present invention claimed in the following claims.

What is claimed is:

1. A method of analyzing bonded part durability test result data, comprising the steps of:
calculating a reference durability lifespan approximation function capable of estimating a durability lifespan value of a bonded part using a thickness value of at least one of two steel sheets to which a reference bonding method of bonding the two steel sheets to each other is applied as an independent variable;
calculating a target durability lifespan approximation function capable of estimating the durability lifespan value of the bonded part using the thickness value of the at least one of two steel sheets to which a target bonding method capable of increasing a durability lifespan value as compared with the reference bonding method is applied as an independent variable;
calculating an inverse function of the target durability lifespan approximation function capable of deriving a thickness value of the at least one steel sheet, which is the independent variable in the target durability lifespan approximation function calculating the same durability lifespan value as a specific durability lifespan value calculated when the independent variable in the reference durability lifespan approximation function is a specific thickness value; and
calculating any target steel sheet thickness value by substituting any target lifespan value into the inverse function of the target durability lifespan approximation function.

2. The method of analyzing bonded part durability test result data according to claim 1, wherein the durability lifespan approximation function and the target durability lifespan approximation function are calculated as approximation functions deriving a plurality of durability lifespan values using the thickness value of the at least one steel sheet as the independent variable by curve-fitting a plurality of durability lifespan values repeatedly measured in a load lower limit value to a load upper limit value that is generated in a vehicle through a method of measuring durability of the bonded part.

3. The method of analyzing bonded part durability test result data according to claim 2, wherein in the method of measuring durability of the bonded part, the load lower limit value to the load upper limit value are simultaneously applied to bonded parts of the two steel sheets in a vertical direction and a horizontal direction.

4. The method of analyzing bonded part durability test result data according to claim 1, further comprising a corresponding showing step in which the thickness value of the steel sheet, which is the independent variable of the reference durability lifespan approximation function, and any target steel sheet thickness value derived by the inverse function of the target durability lifespan approximation function are shown so as to correspond to each other.
